(19) United States
(12) Patent Application Publication
(10) Pub. No.: US 2009/0249948 A1
(43) Pub. Date: Oct. 8, 2009

(54) AIR-SEPARATION APPARATUS FOR USE IN HIGH AMBIENT TEMPERATURE ENVIRONMENTS

(75) Inventor: Thomas J. Jeffers, Spring, TX (US)

Correspondence Address: WILLIAM H. EILBERG, 316 CALIFORNIA AVE. #785, RENO, NV, 89509, US

(73) Assignee: Generon IGS, Inc., Houston, TX (US)

(21) Appl. No.: 12/410,590

(22) Filed: Mar. 25, 2009

Related U.S. Application Data
(60) Provisional application No. 61/042,357, filed on Apr. 4, 2008.

(51) Int. Cl. B01D 53/22

(52) U.S. Cl. 95/39; 96/4; 96/9

(57) ABSTRACT

An air-separation system, useful in high-temperature environments, produces a superheated compressed air stream which is sufficiently cool to be applied to an air-separation membrane. Ambient air is compressed, and then cooled by a fan. The cooled compressed air, after being filtered, is passed through a heat exchanger where it is heated by thermal contact with incoming compressed air. The cooled compressed air thus becomes superheated, and can then be conveyed into a polymeric membrane module without damaging the polymer. A valve enables some of the compressed air to bypass the heat exchanger, thus controlling the degree to which the cooled compressed air stream is heated.

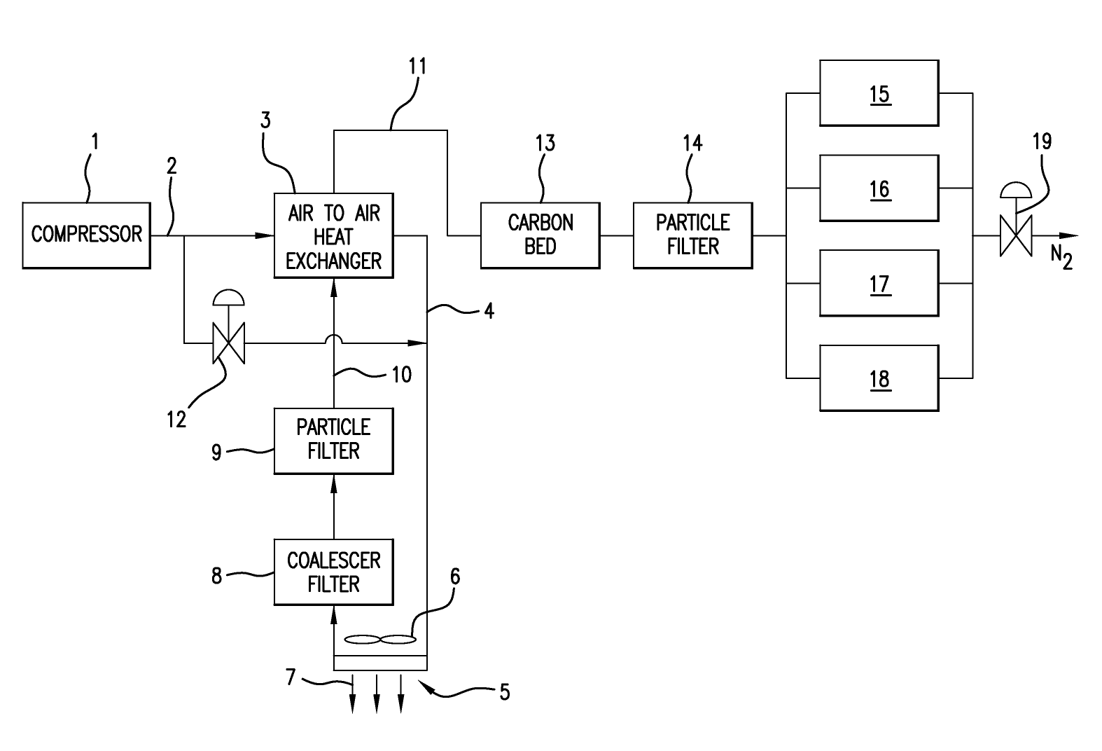

### CROSS-REFERENCE TO PRIOR APPLICATION

Priority is claimed from U.S. provisional patent application Ser. No. 61/042,357, filed Apr. 4, 2008, the entire disclosure of which is incorporated by reference herein.

### BACKGROUND OF THE INVENTION

The present invention relates to the field of non-cryogenic separation of gases into components, and provides an improved system and method especially suited for use in locations having a high ambient temperature.

It has been known to use a polymeric membrane to separate air into components. Various polymers have the property that they allow different gases to flow through, or permeate, the membrane, at different rates. A polymer used in air separation, for example, will pass oxygen and nitrogen at different rates. The gas that preferentially flows through the membrane wall is called the “permeate” gas, and the gas that tends not to flow through the membrane is called the “non-permeate” or “retentate” gas. The selectivity of the membrane is a measure of the degree to which the membrane allows one component, but not the other, to pass through.

An example of a membrane-based air separation system is given in U.S. Pat. No. 4,881,953, the disclosure of which is incorporated by reference herein.

A membrane-based air separation system has the inherent advantage that the system does not require the transportation, storage, and handling of cryogenic liquids. Also, a membrane system requires relatively little energy. The membrane itself has no moving parts; the only moving part in the overall membrane system is usually the compressor which provides the air to be fed to the membrane.

An air separation membrane unit is typically provided in the form of a module containing a large number of small, hollow fibers made of the selected polymeric membrane material. The module is generally cylindrical, and terminates in a pair of tubesheets which anchor the hollow fibers. The tubesheets are impervious to gas. The fibers are mounted so as to extend through the tubesheets, so that gas flowing through the interior of the fibers (known in the art as the bore side) can effectively bypass the tubesheets. But gas flowing in the region external to the fibers (known as the shell side) cannot pass through the tubesheets.

In operation, a compressed gas, such as compressed air, is introduced into a membrane module, the gas being directed to flow through the bore side of the fibers. One component of the gas permeates through the fiber walls, and emerges on the shell side of the fibers, while the other, non-permeate (retentate), component tends to flow straight through the bores of the fibers. The non-permeate component comprises a product stream that emerges from the bore sides of the fibers at the outlet end of the module. By controlling the flow of the non-permeate (retentate) component, one can control the concentration of the permeate component, because a change in pressure in the bores of the fibers will directly affect the permeation of gas through the fibers. A valve in the outlet conduit carrying the retentate component can be used to control the flow of retentate. Such control may be automated. That is, a computer can be connected to control the valve in response to a measured concentration of a component in the permeate stream.

Examples of fiber membrane modules are given in U.S. Patent Application Publication No. 2006-0266217 A1, published Nov. 30, 2006, U.S. Patent Application Publication No. 2007-0261554 A1, published Nov. 15, 2007, and U.S. Patent Application Publication No. 2008-0035270 A1, published Feb. 14, 2008, and in U.S. Pat. No. 7,497,894, issued Mar. 3, 2009. The disclosures of all of the latter publications are hereby incorporated by reference.

A polymer membrane becomes degraded in the presence of liquid water. Therefore, the air directed into the membrane must be substantially free of liquid water. For this reason, the incoming air is typically provided in the form of a superheated gas, i.e. the air has a temperature above its saturation temperature.

The air supplied to a membrane module must also be free of particulates and oil vapor, such as the particles of oil, and the oil vapors, which leak from the compressor. Carbon beds are typically used to remove such particles of oil, and the oil vapor, from the air stream. But excessive humidity also degrades the performance of such carbon beds, which is another reason why the air supplied to the module must be liquid free.

To insure that the incoming air is dry and superheated, the air entering the fiber membrane module preferably has a temperature of at least about 10° F above saturation temperature. In the prior art, the air has been superheated by an electric heater.

Notwithstanding the above considerations, the polymeric fibers in the membrane must not become too hot. If the gas stream entering the module is too hot, it will have a very detrimental effect on the longevity and operating efficiency of the fibers. Typical modules are rated for use at temperatures not exceeding about 130° F.

In environments where the ambient temperature is already relatively high, the requirement for superheated air makes it difficult to achieve the above objectives. For example, in desert environments, the ambient temperature could be in the range of 100-140° F. Typical air compressors include integrated aftercoolers which discharge the compressed air at a temperature of about 20° F. above ambient temperature. In such desert environments, if the output of the compressor is presented to the fiber membrane module, the air could have a temperature in the range of 120-160° F. This range extends beyond the acceptable limits for many fiber membrane modules.

The present invention provides an air-separation system and method which overcomes the above-described problem, and which is therefore well suited for operation in locations where the ambient temperature is relatively high. The invention is particularly suited for use in a portable system, but can also be used in fixed installations.

### SUMMARY OF THE INVENTION

The present invention comprises an apparatus and method for non-cryogenic separation of air, the invention being especially useful in environments having a high ambient temperature. In brief, the method of the present invention provides compressed air for presentation to an air-separation module, wherein the compressed air is superheated, but still within the operating temperature limit of the module.

According to the present invention, a compressor provides a stream of compressed, heated air. The compressed and heated air is conveyed, in a conduit, to a cooling area, wherein air is blown over the conduit. The air is thus cooled to about 10° F. above ambient temperature. The cooled, compressed air is then passed through coalescer and particle filters, to remove liquid, and to remove solid particles, from the stream. The stream is then directed through an air-to-air heat exchanger, in which the stream is heated by thermal contact with at least a portion of the incoming hot compressed air from the compressor.

Thus, the heat from the compressed air produces the superheated air stream, by heating that stream in the air-to-air heat exchanger. But due to the action of the cooling fan, the temperature of the air stream is still below the limit established for a fiber membrane module. The air can therefore be injected into the air-separation module, without damaging the fibers.

Because the present invention produces a superheated air stream at a relatively low temperature, the invention is particularly suited for use in environments where the ambient temperature is high. The invention is especially preferred for use in a desert, where ambient temperatures can often exceed 100° F.

The apparatus of the present invention is suitable for use as a portable nitrogen generator, due to its use of a simple heat exchanger, which has no moving parts, and a simple cooling fan. The apparatus can easily be mounted on a vehicle for transportation to various remote locations where a temporary supply of nitrogen is needed.

The present invention therefore has the primary object of providing an air-separation system and method.

The invention has the further object of providing an air-separation system and method, intended for use in environments having a high ambient temperatures.

The invention has the further object of providing an air-separation system and method, in which the air stream that is injected into a fiber membrane module is superheated but at a sufficiently low temperature to avoid damage to the module.

The invention has the further object of providing an air-separation system and method as described above, wherein the invention is especially useful as a portable nitrogen generator.

The reader skilled in the art will recognize other objects and advantages of the invention, from a reading of the following brief description of the drawing, the detailed description of the invention, and the appended claims.

### BRIEF DESCRIPTION OF THE DRAWING

The FIGURE provides a block diagram, partly in schematic form, showing the air-separation apparatus of the present invention.

### DETAILED DESCRIPTION OF THE INVENTION

The FIGURE shows the air-separation apparatus of the present invention. Compressor 1 receives ambient air and compresses it. The compressed air is directed, through conduit 2, to air-to-air heat exchanger 3. The air leaves heat exchanger 3 through conduit 4, and passes to cooling area 5. The air in the conduit is cooled by fan 6, which blows air over the conduit. Arrows 7 indicate the air which has been blown by the fan over the conduit, and which has become heated, in accomplishing the above-described cooling. This heated air is ejected to the outside environment.

The amount of cooling achieved by the fan depends on the design parameters of the system, such as the size of the conduit, the speed of the blower, the flow rate of the air, etc. In a preferred embodiment, the air in the conduit is cooled to about 10° F. above ambient temperature.

The cooled air then passes through coalescer filter 8 and particle filter 9. The coalescer filter removes fine particles of liquid water from the compressed air stream, and the particle filter removes solid particles from the stream. The filtered air stream, flowing in conduit 10, then re-enters heat exchanger 3 through a path which is distinct from that of the first passage of the air. That is, the heat exchanger defines two distinct passages for gas flow, the passages being in sufficient proximity to allow heat exchange between the two streams.

The air stream flowing into the heat exchanger, from conduit 10, therefore becomes heated by heat exchange with the incoming compressed air entering from conduit 2. Thus, the output of the heat exchanger, which flows in conduit 11, comprises superheated, compressed air.

Valve 12 allows some compressed air, from compressor 1, to bypass the heat exchanger. Depending on the setting of the valve, some or all of the compressed air is diverted from the heat exchanger, and flows directly into conduit 4. The purpose of the valve is to regulate the amount of heating of the air stream. The greater the proportion of compressed air that bypasses the heat exchanger, the less the stream entering from conduit 10 will be heated. The valve therefore serves as a control which prevents air having an excessive temperature from reaching the fiber modules.

The superheated air in conduit 11 is then passed through carbon bed 13 and particle filter 14. The air stream is then fed, in parallel, to a plurality of polymeric fiber membrane modules, indicated by reference numerals 15, 16, 17, and 18. There may be more or fewer such modules than are shown in the drawing. Valve 19 regulates the flow of nitrogen-enriched air exiting the system. Valve 19 therefore serves as a purity control, as it regulates the proportion of nitrogen in gas flowing downstream of the apparatus.

The air-separation apparatus of the present invention is especially suited for use in a portable nitrogen generator. The reasons are that the heat exchanger has no moving parts, the electrical demand on the fan used in cooling is relatively modest, and the compressor can be provided as a diesel-powered portable compressor.

In a portable system, the components are provided on a vehicle capable of traveling to remote locations where nitrogen is needed on a temporary basis. The nitrogen may be used as a drilling fluid, or as a purge gas for pipelines, or in pressurizing a well to extract oil from another well in the vicinity, or for other purposes. The nitrogen could also be used in various industrial plants in fields other than the oil industry.

Although the apparatus is considered useful with portable systems, it is not limited to use with such systems, but can also be used in fixed installations.

The invention also includes the method of separating air in an environment having high ambient temperature. In this method, air is compressed, and some or all of the compressed air is cooled, by blowing air onto a conduit conveying the air stream, and then filtered to remove liquid, and to remove solid particles. The filtered and cooled stream is then passed in proximity with the incoming hot compressed air, so that the filtered and cooled stream becomes heated. In particular, the filtered and cooled stream is superheated, such that the air stream is sufficiently dry, sufficiently clean, and sufficiently cool to be presented safely to a fiber membrane module for separation into components. The resulting nitrogen, or nitrogen-enriched air, can then be used in downstream processes.

The present invention eliminates the need for an electric heater, as the stream of compressed air is instead superheated by heat exchange with the incoming hot compressed air. The cooling area 5 is integrated into the system.

In summary, the invention produces superheated air, suitable for presentation to an air-separation membrane, wherein the temperature of the superheated air is reduced sufficiently to enable the superheated air to be injected safely into the membrane module. The invention enables fiber membrane technology to generate on-site nitrogen in regions which are currently severely limited by high ambient temperatures.

The reader skilled in the art will recognize that the invention can be modified in various ways. The specific details of the membrane modules, the heat exchanger, and the various filters, can be varied. These and other modifications should be considered within the spirit and scope of the following claims.

What is claimed is:

1. Apparatus for non-cryogenic separation of air in a high-temperature environment, the apparatus comprising:
a) a compressor,
b) a heat exchanger connected to receive compressed air from the compressor,
c) means for cooling compressed air which has exited the heat exchanger,
d) means for directing cooled compressed air, which has exited the cooling means, through the heat exchanger, wherein the cooled compressed air becomes superheated by heat exchange with compressed air from the compressor, and
e) means for conveying superheated compressed air exiting the heat exchanger to a gas-separation membrane.

2. The apparatus of claim 1, further comprising a valve connected to receive compressed air from the compressor, the valve comprising means for bypassing the heat exchanger and for conveying compressed air directly to the cooling means.

3. The apparatus of claim 1, wherein the cooling means comprises a fan which is positioned to blow air over a conduit conveying compressed air which has exited the heat exchanger.

4. The apparatus of claim 3, further comprising a coalescer filter for removing liquid from cooled compressed air which has been cooled by the fan.

5. The apparatus of claim 4, further comprising a particle filter for removing particles from cooled compressed air which has been cooled by the fan.

6. The apparatus of claim 1, further comprising filter means positioned upstream of the gas-separation membrane.

7. The apparatus of claim 6, wherein the filter means includes at least one member selected from the group consisting of a carbon bed and a particle filter.

8. Apparatus for producing a superheated stream of compressed air in a high-temperature environment, comprising:
a) a compressor for producing compressed air,
b) a heat exchanger positioned to receive compressed air from the compressor,
c) means for cooling compressed air which has passed through the heat exchanger, and
d) means for directing cooled compressed air back to the heat exchanger and for withdrawing superheated compressed air from the heat exchanger.

9. The apparatus of claim 8, further comprising a valve connected to receive compressed air from the compressor, the valve comprising means for bypassing the heat exchanger and for conveying compressed air directly to the cooling means.

10. The apparatus of claim 8, wherein the cooling means comprises a fan which is positioned to blow air over a conduit conveying compressed air which has exited the heat exchanger.

11. The apparatus of claim 10, further comprising a coalescer filter for removing liquid from cooled compressed air which has been cooled by the fan.

12. The apparatus of claim 11, further comprising a particle filter for removing particles from cooled compressed air which has been cooled by the fan.

13. A method for non-cryogenic separation of air into components, in a high-temperature environment, the method comprising:
a) compressing ambient air to form a compressed air stream,
b) cooling said compressed air stream to form a cooled compressed air stream,
c) bringing said cooled compressed air stream into thermal contact with compressed air produced by step (a), wherein said cooled compressed air stream becomes a superheated compressed air stream, and
d) conveying said superheated compressed air stream into an air-separation membrane module.

14. The method of claim 13, wherein the cooling step comprises blowing air onto a conduit containing said compressed air stream.

15. The method of claim 13, wherein step (b) is followed by the steps of removing liquid and particles from said cooled compressed air stream.

16. The method of claim 13, further comprising the step of diverting a portion of said compressed air stream produced in step (a) so that said portion is not brought into thermal contact with said cooled compressed air stream.

17. A method for making a superheated stream of compressed air in a high-temperature environment, comprising the steps of:
a) compressing ambient air to form a compressed air stream,
b) cooling said compressed air stream to form a cooled compressed air stream, and
c) bringing said cooled compressed air stream into thermal contact with compressed air produced by step (a), wherein said cooled compressed air stream becomes a superheated compressed air stream.

18. The method of claim 17, wherein the cooling step comprises blowing air onto a conduit containing said compressed air stream.

19. The method of claim 17, wherein step (b) is followed by the steps of removing liquid and particles from said cooled compressed air stream.

20. The method of claim 17, further comprising the step of diverting a portion of said compressed air stream produced in step (a) so that said portion is not brought into thermal contact with said cooled compressed air stream.
